(19) United States
(12) Patent Application Publication
(10) Pub. No.: US 2018/0223653 A1
(43) Pub. Date: Aug. 9, 2018

(54) Downhole Telemetry Systems and Methods

(71) Applicant: Halliburton Energy Services, Inc., Houston, TX (US)

(72) Inventors: Daniel Joshua Stark, Houston, TX (US); John L. Maida, Houston, TX (US); David Andrew Barfoot, Houston, TX (US)

(21) Appl. No.: 15/749,581

(22) PCT Filed: Sep. 15, 2015
(86) PCT No.: PCT/US2015/050247

§ 371 Date: Feb. 1, 2018

(51) Int. Cl. E21B 47/12; G01D 5/26; E21B 47/06; E21B 49/00; E21B 49/08

(52) U.S. Cl. CPC E21B 47/123; G01D 5/268; E21B 49/08; E21B 47/065; E21B 49/00; E21B 47/06

(57) ABSTRACT

A downhole telemetry system comprises an optical fiber, a downhole signal generator, a downhole amplifier, and a first downhole laser. The downhole signal generator can be in optical communication with the optical fiber to generate a signal to be transmitted along the optical fiber. The downhole amplifier can be in optical communication with the optical fiber to receive the signal from the downhole signal generator. The first downhole laser can be in optical communication with the downhole amplifier to generate a first laser light output to power the downhole amplifier. Additional apparatus, methods, and systems are disclosed.

### BACKGROUND

Conventional uplink telemetry, microseismic, and coiled tubing systems utilizing fiber optic communication are limited to a few megabits-per-second (Mbps) operation. Ensuring correct data transmission requires a certain amount of energy per bit, and the limited power budgets of conventional systems thus result in limitations on data rates. Some of these systems use light emitting diodes (LEDs), which have a broad spectral range and low coupling efficiencies into fiber, further contributing to limited data rates. Some of these systems make use of remote pumping, presenting further inefficiencies. For example, light-matter material interaction can result in non-linear optical energy conversion, signal shape degradation, and cross-talk.

### BRIEF DESCRIPTION OF THE DRAWINGS

The present disclosure may be better understood, and its numerous features and advantages made apparent to those of ordinary skill in the art by referencing the accompanying drawings. The use of the same reference symbols in different drawings indicates similar or identical items.

FIG. 1 depicts an example downhole telemetry system, in accordance with some embodiments.

FIG. 2 is a block diagram of an example downhole telemetry system, in accordance with some embodiments.

FIG. 3 is a block diagram of an example downhole telemetry system, in accordance with some embodiments.

FIG. 4 is a flow diagram of an example method of downhole telemetry communication, in accordance with some embodiments.

FIG. 5 depicts an example system at a wireline site, in accordance with some embodiments.

FIG. 6 depicts an example system at a drilling site, in accordance with some embodiments.

### DETAILED DESCRIPTION

To address some of the challenges presented above, as well as others, various embodiments operate to provide a non-remotely pumped telemetry system that may include both an uplink telemetry system and a downlink telemetry system. In some embodiments, a high temperature laser is used to provide superior optical power output and narrower bandwidths, increasing the power budget and reducing the effect of dispersion to increase the possible bandwidth of data transmission. In some embodiments, the high temperature laser is in communication with a single mode optical fiber and a modulator to encode the laser light output, producing a telemetry signal. In some embodiments, a high temperature laser is pumped to power an amplifier to amplify the telemetry signal, providing higher signal to noise ratios (SNR) for longer distances, or to augment the SNR and increase the possible data rate that can be transmitted . . . .

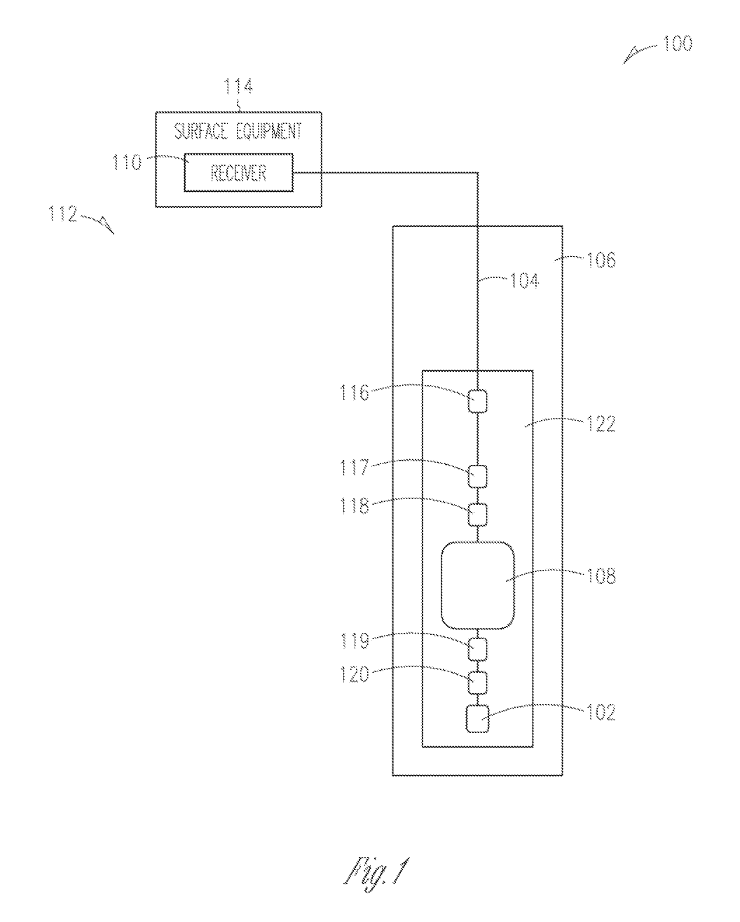

FIG. 1 depicts an example downhole telemetry system 100, in accordance with some embodiments. A downhole laser 102 generates a laser light output at the end of an optical fiber 104, for example a fiber optic cable, down a borehole 106. In at least one example, the optical fiber 106 comprises a single mode optical fiber. In at least one example, the laser comprises a high temperature laser. In some examples, the downhole laser 102 comprises a quantum dot laser. In at least one example, the downhole laser 102 comprises a vertical-cavity surface-emitting laser, a Fabry-Perot laser, a distributed feedback laser, a cooled electro-absorption modulated laser, or the like. In some embodiments, the downhole laser 102 provides power at the end of the optical fiber 104. For example, in at least one embodiment, the downhole laser 102 provides power of from about 100 nanowatts (nW) to about 1 Watt (W). In at least one embodiment, the downhole laser 102 provides power of about 10 mW in silica optical fibers. In some examples, the downhole laser 102 is capable of operating at temperatures greater than approximately 75° C. In at least one example, the downhole laser 102 is capable of operating at temperatures greater than approximately 150° C. In at least one embodiment, the downhole laser 102 is not remotely pumped.

In at least one embodiment, being non-remotely pumped entails co-locating the pump laser and the amplifier or the amplifier and the probe laser. Remote optical pumping may be accomplished by sending a quantity of higher power excitation light (pump light) along the fiber to the remote (downhole) laser cavity containing an active ion medium. Pump light is typically at a different (shorter) optical wavelength than the excited ion's spontaneously emitted “fluorescent” light (via excited-electron state relaxation).

In at least one embodiment, the laser light output generated by the laser passes, via the optical fiber 104, through a downhole modulator 108. In some embodiments, the downhole modulator 108 encodes a telemetry signal. In at least one embodiment, the laser light output is modulated directly in the optical fiber 104 to generate a telemetry signal. For example, in the case of microseismic measurements, the optical fiber 104 may include a sensor to modulate the laser light output directly in the optical fiber 104. In some embodiments, the modulator comprises an electroabsorption modulator, an electro-optic modulator, a semiconductor optical amplifier, a combination of these, or the like. The sensor can comprise a pressure transducer, a temperature transducer, a chemical sensor, a density sensor, a resistivity sensor, a microseismic profiler, a combination of these, or the like.

In some embodiments, the telemetry signal travels through the borehole 106 via the optical fiber 104 to a receiver 110 at the surface of the earth 112. In at least one embodiment, the receiver 110 is in optical communication with the optical fiber 104, such that the receiver 110 receives telemetry data via the optical fiber 104. In some embodiments, the receiver 110 is in electrical communication with surface equipment 114. In at least one embodiment, the surface equipment includes an analyzer to analyze the telemetry data received via the optical fiber 104. In at least one embodiment, the receiver 110 comprises a transceiver, such that the transceiver 110 can send a signal through the borehole 106. For example, in at least one embodiment, the transceiver 110 sends a signal through the borehole 106 to adjust the laser light output of the downhole laser 102.

In some embodiments, the telemetry system 100 includes one or more optical components 116, 117, 118, 119, 120. In the illustrated example, two optical components 119, 120 are depicted along the optical fiber 104 between the downhole laser 102 and the downhole modulator 108, and three optical components 116, 117, 118 are depicted along the optical fiber 104 between the downhole modulator 108 and the surface of the earth 112. In other embodiments, the telemetry system 100 can include the same number of optical components 116, 117, 118, 119, 120, more optical components 116, 117, 118, 119, 120, or less optical components 116, 117, 118, 119, 120, in any arrangement along the optical fiber 104. For example, in one embodiment, the telemetry system 100 includes a single optical component 119 along the optical fiber between the downhole laser 102 and the downhole modulator 108. In at least one example, the telemetry system 100 does not include any additional optical components 116, 117, 118, 119, 120. In another embodiment, the telemetry system 100 includes a single optical component 117 along the optical fiber 104 between the downhole modulator 108 and the surface of the earth 112. Each of the optical components 116, 117, 118, 119, 120 may comprise, for example, a depolarizer, a polarizer, a fiber stretcher, a coupler, a circulator, an isolator, a wavelength division multiplexer, a fiber Bragg grating, a faraday Rotator mirror, an optical receiver, a metallic-coated fiber mirror, an optical mixer, an optical filter, a demultiplexer, additional amplifiers, a combination of these, or the like. In some embodiments, one or more of the downhole laser 102, the downhole modulator 108, the sensor, and optical components 116, 117, 118, 119, 120 are included in a downhole tool 122.

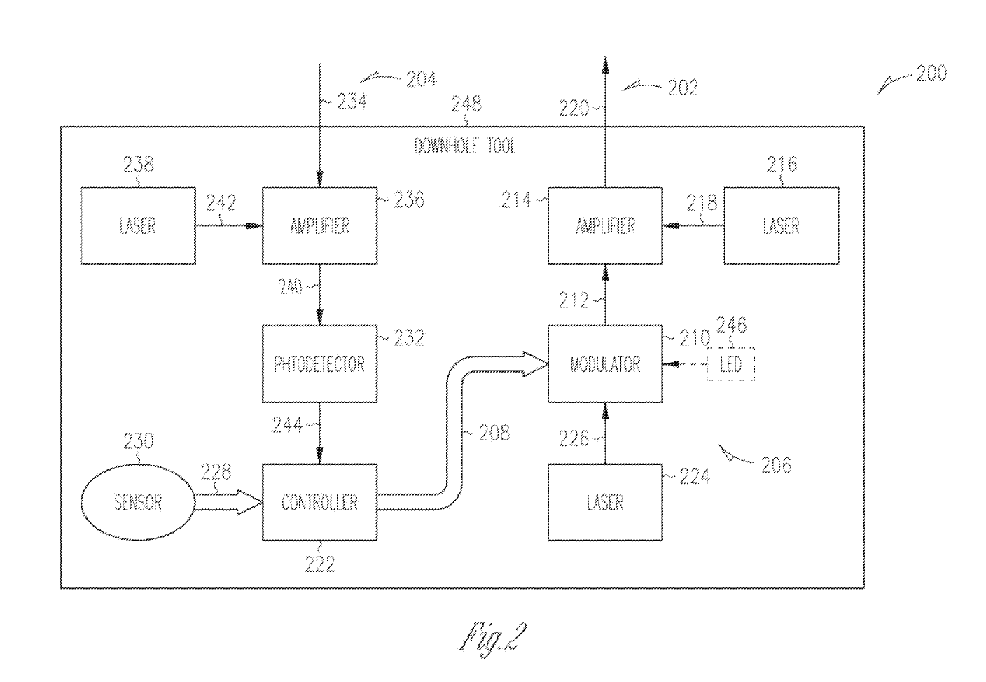

FIG. 2 is a block diagram of an example downhole telemetry system 200, in accordance with some embodiments. In at least one embodiment, the downhole telemetry system 200 comprises a non-remotely pumped telemetry system. The illustrated downhole telemetry system 200 comprises both an uplink telemetry system 202 and a downlink telemetry system 204. However, in other embodiments, the downhole telemetry system 200 may comprise only a downlink telemetry system 204, or only an uplink telemetry system 202. In at least one embodiment, the uplink telemetry system 202 and the downlink telemetry system 204 utilize the same optical fiber. In other embodiments, the uplink telemetry system 202 and the downlink telemetry system 204 utilize separate optical fibers. In at least one embodiment, the optical fiber is a single mode optical fiber.

In some embodiments, a signal generator 206 is in optical communication with the optical fiber to generate a signal in the form of a laser light output 226 to be transmitted along the optical fiber. In at least one embodiment, the signal generator 206 comprises a downhole laser 224 that generates a laser light output 226 and a controller 222 that receives sensor data 228 from one or more sensors 230. The one or more sensors 230 provide data for the telemetry signal 212. In some embodiments, each of the one or more sensors 230 comprise a pressure transducer, a temperature transducer, a microseismic profiler, a chemical sensor, a density sensor, a resistivity sensor, a combination of these, or the like. In some embodiments, the controller 222 processes the sensor data 228 and transmits a sensor data signal 208.

In at least one embodiment, the controller 222 is in electrical communication with the downhole modulator 210. In some embodiments the signal generator 206 comprises a downhole modulator 210 in optical communication with the downhole laser 224 to modulate the laser light output 226 based on the sensor data signal 208 to generate a telemetry signal 212. In at least one embodiment, the optical fiber comprises the downhole modulator 210, such that the optical fiber modulates the laser light output 226. In at least one embodiment, the downhole laser 224 is capable of operating at temperatures greater than approximately 75° C. In at least one embodiment, the downhole laser 224 is not remotely pumped. In some embodiments, the signal generator 206 can comprise, for example, a vertical-cavity surface-emitting laser, a Fabry-Perot laser, a distributed feedback laser, a cooled electro-absorption modulated laser, a combination of these, or the like. While the illustrated embodiment depicts the downhole laser 224 as a laser, in other embodiments, the downhole signal generator 206 may comprise a light emitting diode (LED) 246 or other light source to produce a non-laser light output instead of laser light output 226.

In some embodiments, the uplink telemetry system 202 comprises a downhole amplifier 214 in optical communication with the optical fiber. In some embodiments, the downhole amplifier 214 is to receive the telemetry signal 212 from the downhole signal generator 206. In at least one embodiment, the downhole amplifier 214 comprises an erbium-doped fiber amplifier (e.g., 1525 nm to 1575 nm band). In some embodiments, the downhole amplifier 214 comprises, for example, a Thulium (e.g., 1450 nm-1490 nm band); Praseodymium (e.g., 1300 nm band), and Ytterbium (e.g., 1030 nm to 1070 nm band), or the like. In at least one embodiment, the downhole amplifier 214 comprises a semiconductor optical amplifiers. In some examples the semiconductor optical amplifier is used for wavelengths ranging from about 700 nm to 3000 nm. In at least one embodiment, a downhole laser 216 is in optical communication with the downhole amplifier 214. The downhole laser 216 is to generate a laser light output 218 to power the downhole amplifier 214 and amplify the telemetry signal 212. For example, in some embodiments, the downhole laser 216 acts as a pump for the downhole amplifier 214 while the telemetry signal 212 acts as a probe, which is then amplified.

In some embodiments, the combination of the downhole laser 216 and the downhole amplifier 214 allows for high signal to noise ratios for longer distance telemetry applications (e.g., booster amplifier). For example, in at least one embodiment, the combination of the downhole laser 216 and the downhole amplifier 214 allows for signal to noise ratios of approximately 20 dB better than without an amplifier for a telemetry application of at least about 10 kilofeet (kft). In at least one embodiment for low bit-error-rates, overall optical system SNRs (laser/amplifier, interconnect fiber component, and optical receiver) can be about 30 dB to 40 dB. In some embodiments, the uplink telemetry system 202 comprises the downhole laser 216 and downhole amplifier 214 positioned to amplify the telemetry signal 212 immediately after the laser light output 226 is modulated by the downhole modulator 210, to allow an optical signal 220 to travel to a receiver (or transceiver) at the surface of the earth, while the noise level is still relatively low, countering the attenuation inherent in fiber transmission. The resulting optical signal 220 is a higher power signal than it would be without the amplification provided by the amplifier 214 and the laser 216. The downhole laser 216 can comprise, for example, a vertical-cavity surface-emitting laser, a Fabry-Perot laser, a distributed feedback laser, a cooled electro-absorption modulated laser, a combination of these, or the like. In at least one embodiment, the downhole laser 216 is capable of operating at temperatures greater than approximately 75° C. In at least one embodiment, the downhole laser 216 is not remotely pumped.

In some embodiments, the downlink telemetry system 204 comprises a downhole photodetector 232 to detect an optical signal 234 transmitted from the surface of the earth. In some embodiments, the downlink telemetry system 204 includes a downhole amplifier 236 and a downhole laser 238 to amplify the optical signal 234, transmitting an amplified telemetry signal 240 along the optical fiber to be received by the photodetector 232. In at least one embodiment, the downhole amplifier 236 comprises an erbium-doped fiber amplifier. In some embodiments, the downhole laser 238 is capable of operating at temperatures greater than approximately 75° C. In at least one embodiment, the downhole laser 238 is not remotely pumped. The downhole laser 238 can comprise, for example, a vertical-cavity surface-emitting laser, a Fabry-Perot laser, a distributed feedback laser, a cooled electro-absorption modulated laser, a combination of these, or the like.

Similar to the downhole amplifier 214 and downhole laser 216 of the uplink telemetry system 202 in the illustrated embodiment, the downhole laser 238 generates a laser light output 242 to power the downhole amplifier 236 and amplify the optical signal 234. In the illustrated embodiment of the downlink telemetry system 204, the downhole amplifier 236 amplifies the optical signal 234 after attenuation, increasing both the magnitude of the signal 236 and the noise, as well as the difference between the signal 236 and the noise. In the illustrated example, the amplification after attenuation would augment the signal to noise ratio (SNR) and increase the data rate that may be realized along the optical fiber.

In some embodiments, the downhole telemetry system 200 comprises more than one amplifier in series, in parallel, or a combination of series and parallel. In at least one example, each amplifier of the plurality of amplifiers boosts the power until reaching a predetermined limit, based on safety concerns or the desire to avoid non-linear effects.

In at least one example, a 1550 nm light can be amplified by an erbium-doped fiber amplifier (EDFA), then pass through an ytterbium-doped fiber amplifier (YDFA) with minimal effect, then a 980 nm light could go through the EDFA with little effect to then be pumped by the YDFA, all on the same optical fiber. In some examples, amplifiers on separate fibers could be brought in together by a wavelength-division multiplexer (WDM MUX).

In at least one embodiment, the photodetector 232 translates the telemetry signal 240 into an electronic signal 244 to be communicated to the controller 222 in electrical communication with the photodetector 232. For example, in at least one embodiment, the electronic signal 244 could include commands for the controller 222, such as a command to obtain sensor data 228 from the one or more sensors 230. In some examples, the controller 222 would collect sensor data 228 from the one or more sensor 230, interpret the sensor data 228, and send the sensor data signal 208 to the downhole modulator 210 to adjust the laser light output 226 produced by the downhole laser 224. In some embodiments, a downhole tool 248 houses one or more components 206, 210, 214, 216, 222, 224, 230, of the downhole telemetry system 200, a second laser, a second amplifier, a photodetector, or the like.

In at least one embodiment, the downhole telemetry system 200 is a non-remotely pumped telemetry system. Remote optical pumping can lead to light-matter material interaction, within the optical fiber, resulting in non-linear optical energy conversion along said fiber as the high power pump light propagates along the fiber length. This degrades signal shape, adds cross talk in adjacent multiplexed channels. Examples of optical non-linearities include: Stimulated Raman Scattering; Stimulated Brillouin scattering; Self-Phase Modulation; Cross-Phase Modulation; Four-Wave Mixing; and Supercontinuum Generation. Further, with remote optical pumping, the power required for the pump light to be effective often exceeds desirable eye safety (class 1M) and explosion proof regulations.

In some embodiments the optical connection between the surface optical equipment and downhole optical equipment is made through a disposable telemetry cable deployment system. In at least one embodiment, the connection system includes an optical slip ring.

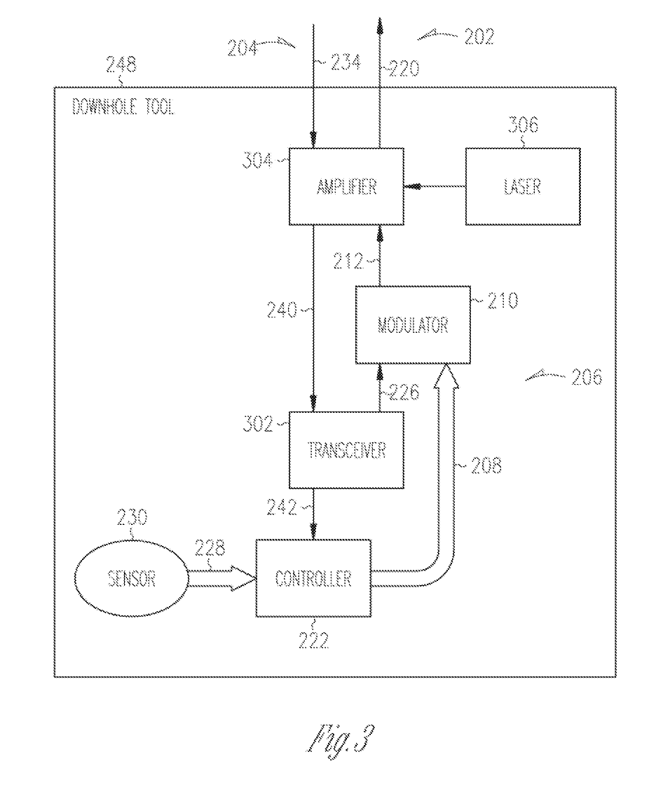

FIG. 3 is a block diagram of an example downhole telemetry system 300, in accordance with some embodiments. In some embodiments, the downhole telemetry system 300 includes a transceiver 302 which performs the functions of both the downhole laser 224 and the photodetector 232 in the example downhole telemetry system 200 illustrated in FIG. 2. That is, the transceiver 302 forms part of the signal generator 206 of the uplink telemetry system 202, generating the laser light output 226 to be received by the downhole modulator 210 via the optical fiber. In some examples, the transceiver comprises a light source other than a laser, such as a light emitting diode (LED) or other light source that produces light output 226. Transceiver 302 also forms part of the downlink telemetry system 204, detecting the optical signal 234, or in the illustrated embodiment, the amplified telemetry signal 240, to translate the telemetry signal 240 into the electronic signal 244 communicated to the controller 222.

In some embodiments, the downhole telemetry system 300 includes a downhole amplifier 304 and a downhole laser 306 that serves to amplify signals 212, 234 of both the uplink telemetry system 202 and the downlink telemetry system. That is, downhole amplifier 304 performs the functions of both downhole amplifier 214 and downhole amplifier 236 of the example downhole telemetry system 200 illustrated in FIG. 2, and downhole laser 306 performs the functions of both downhole laser 218 and downhole laser 238 of the example downhole telemetry system 200 illustrated in FIG. 2

In some embodiments, the downhole telemetry system 300 includes the transceiver 302, as well as separate downhole amplifiers 214, 236 and downhole lasers 216, 238 for the uplink telemetry system 202 and the downlink telemetry system 204. In some embodiments, the downhole telemetry system 300 includes the amplifier 304 and the downhole laser 306 shared by both the uplink telemetry system 202 and the downlink telemetry system 204, as well as a separate photodetector 232 for the downlink telemetry system 204 and a downhole laser 224 for the uplink telemetry system. In some embodiments, the downlink telemetry system 204 and the uplink telemetry system 202 send one or more optical signals 234, 240, 220, 212, 226 along the same optical fiber. In other embodiments, the uplink telemetry system 202 and the downlink telemetry system 204 do not share an optical fiber. In at least one embodiment, the downhole telemetry system 300 is a non-remotely pumped telemetry system.

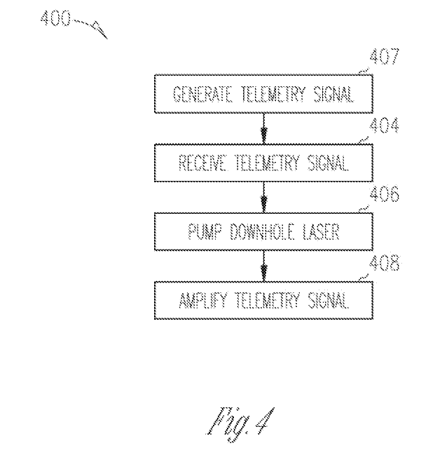

FIG. 4 is a flow diagram of an example method 400 of downhole telemetry communication, in accordance with some embodiments. As a matter of convenience, the downhole telemetry method 400 is described with reference to the downhole telemetry system 200 as illustrated in FIG. 2. At block 402, the downhole signal generator 206 or surface equipment 114 (see FIG. 1) generates a telemetry signal 212, 234. In the case of the downlink telemetry system 204, the surface equipment 114 generates a down-going telemetry signal 234. In the case of the uplink telemetry system 202, the controller 222 samples the one or more sensors 230 to collect sensor data 228. The controller 222 processes the sensor data 228 and transmits a sensor data signal 208 to the downhole modulator 210. The downhole laser 224 produces the laser light output 226 to power the downhole modulator 210 via the optical fiber 104 (see FIG. 1). The downhole modulator 210 modulates the laser light output 226 of the downhole laser 224 and generates the up-going telemetry signal 212 based on the sensor data signal 208 and the laser light output 226.

At block 404, the downhole amplifier 214, 236 receives the telemetry signal 212, 234 from the optical fiber 104. In the case of the downlink telemetry system 204, the downhole amplifier 236 is optically coupled to the surface equipment 114 via the optical fiber 104, such that the surface equipment 114 transmits the telemetry signal 234 along the optical fiber 104 to be received by the amplifier 236. In the case of the uplink telemetry system 202, the downhole modulator 210 is optically coupled to the downhole amplifier 214 via the optical fiber 104, such that the downhole modulator 210 transmits the telemetry signal 212 along the optical fiber 104 to be received by the downhole amplifier 214.

At block 406, the downhole laser 216, 238 is pumped to produce the laser light output 218, 242 to power the downhole amplifier 214, 236. In at least one embodiment, pumping the downhole laser 216, 238 does not comprise remote pumping. At block 408, the downhole amplifier 214, 236, powered by the downhole laser 216, 238, amplifies the telemetry signal 212, 234 to produce an amplified telemetry signal 220, 240. In the case of the uplink telemetry system 202, amplifying the telemetry signal 212 by powering the downhole amplifier 214 with the downhole laser 216 allows for high signal to noise ratios for longer distance telemetry applications (e.g., greater than 10 kilofeet). In at least one embodiment, the receiver 110 (see FIG. 1) at the surface of the earth 112 receives the amplified telemetry signal 220. In some embodiments of the uplink telemetry system 202, the downhole amplifier 214 amplifies the telemetry signal 212 immediately after the downhole modulator 210 modulates the laser light output 226 to allow an optical signal 220 to travel to the receiver (or transceiver) 110 at the surface of the earth 112, while the noise level is still relatively low, countering the attenuation inherent in fiber transmission.

In some embodiments of the downlink telemetry system 104, the downhole amplifier 236 amplifies the optical signal 234 after attenuation, augmenting the signal to noise ratio (SNR) and increasing the possible data rate along the optical fiber 104. In at least one embodiment of the downlink telemetry system 104, the photodetector 232 detects the amplified telemetry signal 240 and converts it to an electronic signal 244 to transmit commands or other information to the controller 222.

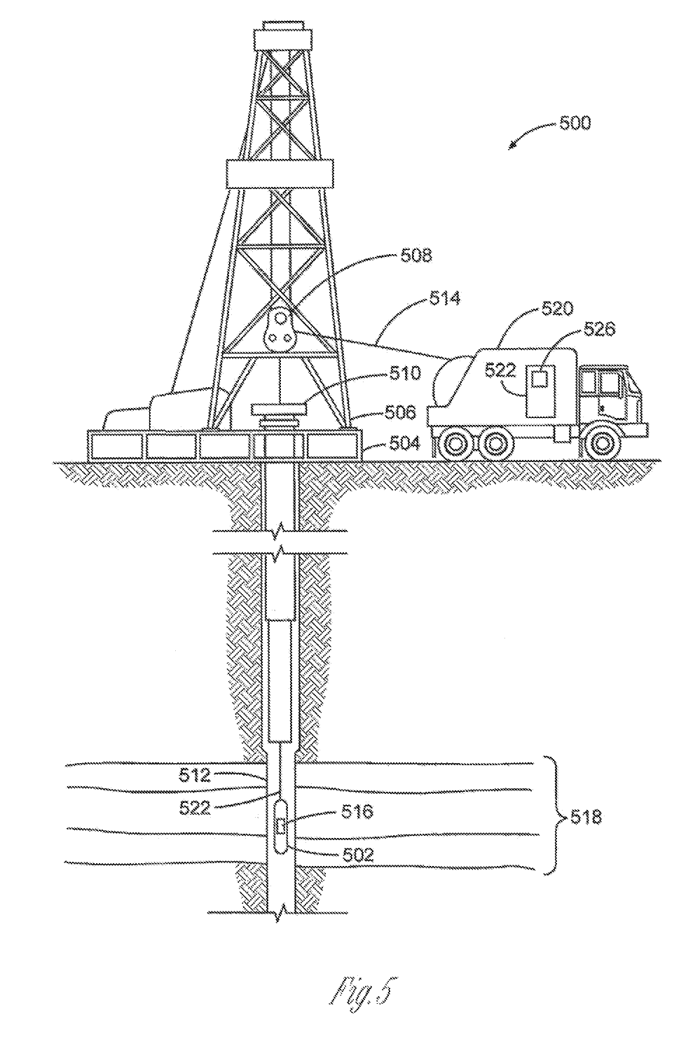

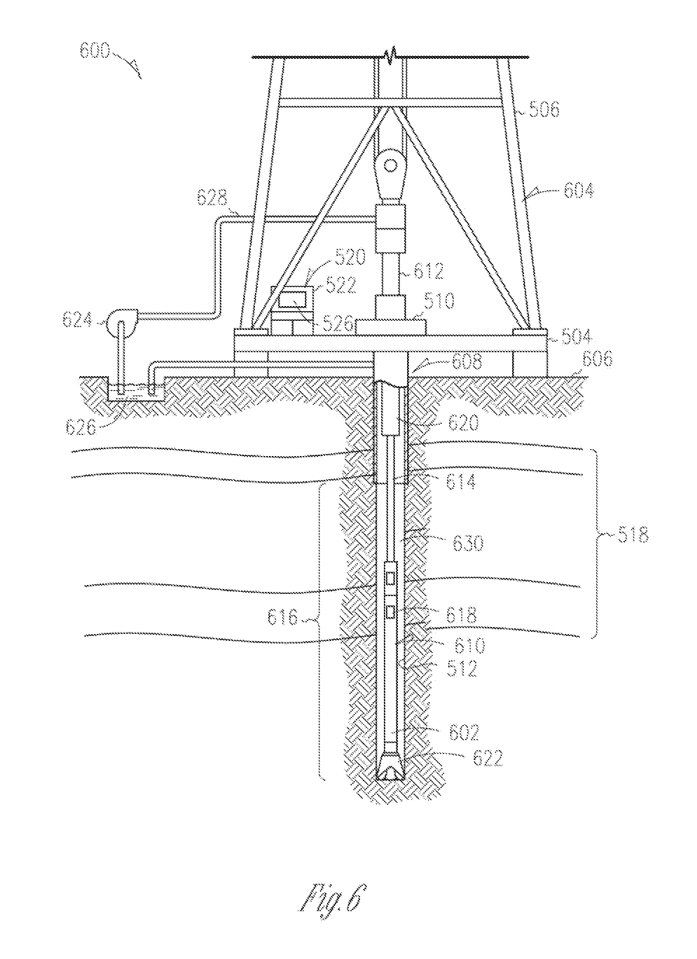

FIG. 5 is a diagram showing a wireline system 500 embodiment, and FIG. 6 is a diagram showing a logging while drilling (LWD) system 600 embodiment. The systems 500, 600 may thus comprise portions of a wireline logging tool body 502 as part of a wireline logging operation, or of a down hole tool 602 as part of a down hole drilling operation.

FIG. 5 illustrates a well used during wireline logging operations. In this case, a drilling platform 504 is equipped with a derrick 506 that supports a hoist 508. Drilling oil and gas wells is commonly carried out using a string of drill pipes connected together so as to form a drillstring that is lowered through a rotary table 510 into a wellbore or borehole 512. Here it is assumed that the drillstring has been temporarily removed from the borehole 512 to allow a wireline logging tool body 502, such as a probe or sonde, to be lowered by wireline or logging cable 514 (e.g., slickline cable) into the borehole 512. Typically, the wireline logging tool body 502 is lowered to the bottom of the region of interest and subsequently pulled upward at a substantially constant speed. The tool body 502 may include downhole spectroscopy system 516 (which may include any one or more of the elements of systems 100, 200 or 300 of FIGS. 1-3).

During the upward trip, at a series of depths various instruments (e.g., co-located with the downhole spectroscopy system 516 included in the tool body 502) may be used to perform measurements on the subsurface geological formations 518 adjacent to the borehole 512 (and the tool body 502). The measurement data can be communicated to a surface logging facility 520 for processing, analysis, and/or storage. The processing and analysis may include natural gamma-ray spectroscopy measurements and/or determination of formation density. The logging facility 520 may be provided with electronic equipment for various types of signal processing. Similar formation evaluation data may be gathered and analyzed during drilling operations (e.g., during LWD/MWD (measurement while drilling) operations, and by extension, sampling while drilling).

In some embodiments, the tool body 502 is suspended in the wellbore by a wireline cable 514 that connects the tool to a surface control unit (e.g., comprising a workstation 522). The tool may be deployed in the borehole 512 on coiled tubing, jointed drill pipe, hard wired drill pipe, or any other suitable deployment technique.

Referring to FIG. 6, it can be seen how a system 600 may also form a portion of a drilling rig 604 located at the surface 606 of a well 608. The drilling rig 604 may provide support for a drillstring 610. The drillstring 610 may operate to penetrate the rotary table 510 for drilling the borehole 512 through the subsurface formations 518. The drillstring 610 may include a Kelly 612, drill pipe 614, and a bottom hole assembly 616, perhaps located at the lower portion of the drill pipe 614. As can be seen in the figure, the drillstring 610 may include a downhole spectroscopy system 618 (which may include any one or more of the elements of system 100, 200 or 300 of FIGS. 1-3).

The bottom hole assembly 616 may include drill collars 620, a down hole tool 602, and a drill bit 622. The drill bit 622 may operate to create the borehole 512 by penetrating the surface 606 and the subsurface formations 518. The down hole tool 602 may comprise any of a number of different types of tools including MWD tools, LWD tools, and others. In other embodiments, the downhole spectroscopy system 618 can be located anywhere along the drillstring 610, including as part of the downhole tool 602.

During drilling operations, the drillstring 610 (perhaps including the Kelly 612, the drill pipe 614, and the bottom hole assembly 616) may be rotated by the rotary table 510. Although not shown, in addition to, or alternatively, the bottom hole assembly 616 may also be rotated by a motor (e.g., a mud motor) that is located down hole. The drill collars 620 may be used to add weight to the drill bit 622. The drill collars 620 may also operate to stiffen the bottom hole assembly 616, allowing the bottom hole assembly 616 to transfer the added weight to the drill bit 622, and in turn, to assist the drill bit 622 in penetrating the surface 606 and subsurface formations 518.

During drilling operations, a mud pump 624 may pump drilling fluid (sometimes known by those of ordinary skill in the art as “drilling mud”) from a mud pit 626 through a hose 628 into the drill pipe 614 and down to the drill bit 622. The drilling fluid can flow out from the drill bit 622 and be returned to the surface 606 through an annular area 630 between the drill pipe 614 and the sides of the borehole 512. The drilling fluid may then be returned to the mud pit 626, where such fluid is filtered. In some embodiments, the drilling fluid can be used to cool the drill bit 622, as well as to provide lubrication for the drill bit 622 during drilling operations. Additionally, the drilling fluid may be used to remove subsurface formation cuttings created by operating the drill bit 622.

The workstation 522 and the controller 526 may include modules comprising hardware circuitry, a processor, and/or memory circuits that may store software program modules and objects, and/or firmware, and combinations thereof, as desired by the architect of the downhole spectroscopy system 516, 618 and as appropriate for particular implementations of various embodiments. For example, in some embodiments, such modules may be included in an apparatus and/or system operation simulation package, such as a software electrical signal simulation package, a power usage and distribution simulation package, a power/heat dissipation simulation package, and/or a combination of software and hardware used to simulate the operation of various potential embodiments.

Thus, many embodiments may be realized. Some of these will now be listed as non-limiting examples.

In some embodiments, a system comprises a downhole sub to attach to a drill string and a vibration component mechanically coupled to the downhole sub to generate a selected vibration in the drill string when the downhole sub is attached to the drill string.

In some embodiments, a system comprises an optical fiber, a downhole signal generator in optical communication with the optical fiber, the downhole signal generator to generate a signal to be transmitted along the optical fiber, a downhole amplifier in optical communication with the optical fiber, the downhole amplifier to receive the signal from the downhole signal generator, and a first downhole laser in optical communication with the downhole amplifier, the downhole laser to generate a first laser light output to power the downhole amplifier.

In some embodiments, the downhole laser is capable of operating at temperatures greater than approximately 75° C.

In some embodiments, the downhole signal generator comprises a second downhole laser in optical communication with the optical fiber, the second downhole laser to generate a second laser light output, and a downhole modulator in optical communication with the second downhole laser, the downhole modulator to modulate the second laser light output to generate a telemetry signal.

In some embodiments, the optical fiber comprises the downhole modulator.

In some embodiments, the second downhole laser comprises the downhole modulator.

In some embodiments, the system further comprises a second downhole amplifier connected in series or parallel with the first downhole amplifier.

In some embodiments, the system further comprises a third downhole amplifier, wherein the first, second, and third downhole amplifiers are connected in series, in parallel, or in a combination of series and parallel.

In some embodiments, the system further comprises a receiver at the surface of the earth, the receiver in communication with the optical fiber to receive telemetry data via the optical fiber.

In some embodiments, the downhole laser comprises a quantum dot laser.

In some embodiments, the downhole laser is selected from the group consisting of: a vertical-cavity surface-emitting laser, a Fabry-Perot laser, a distributed feedback laser, and a cooled electro-absorption modulated laser.

In some embodiments, the system further comprises a sensor to provide data to be included in the signal, the sensor selected from the group consisting of: a pressure transducer, a temperature transducer, a chemical sensor, a density sensor, a resistivity sensor, a magnetic field sensor, a radiation sensor, and a microseismic profiler.

In some embodiments, the system comprises a downlink telemetry system.

In some embodiments, the system comprises a non-remotely pumped telemetry system, wherein the downhole laser is not remotely pumped.

In some embodiments, the system further comprises one or more downhole optical components optically coupled to the optical fiber, the one or more downhole optical components selected from the group consisting of: a depolarizer, a polarizer, fiber stretcher, a coupler, a circulator, an isolator, a wavelength division multiplexer, a fiber Bragg grating, a faraday Rotator mirror, an optical receiver, a metallic-coated fiber mirror, an optical mixer, an optical filter, and a demultiplexer.

In some embodiments, a method comprises receiving, at a downhole amplifier, a signal from an optical fiber, producing, at a first downhole laser, a first laser light output to power the downhole amplifier, and amplifying, at the downhole amplifier, the signal using the first laser light output.

In some embodiments, the method comprises generating the signal by generating, at a second downhole laser, a second laser light output to be received by a downhole modulator, and modulating, at the downhole modulator, the second laser light output to produce a telemetry signal.

In some embodiments, the signal comprises a down-going telemetry signal.

In some embodiments, the method further comprises receiving, at a downhole receiver, the down-going telemetry signal.

In some embodiments, the method comprises receiving, at a receiver at the surface of the earth, the downhole signal via the optical fiber.

In some embodiments, the method comprises adjusting the first laser light output based on information provided by at least one sensor.

In some embodiments, a non-remotely pumped telemetry system comprises a single mode optical fiber, a first downhole laser in optical communication with the optical fiber, the first downhole laser to produce a first laser light output, a downhole modulator in optical communication with the optical fiber, such that the downhole modulator modulates the first laser light output to produce a telemetry signal, a downhole amplifier in optical communication with the optical fiber, the downhole amplifier to amplify the telemetry signal, and a second downhole laser in optical communication with the downhole amplifier, the second downhole laser to produce a second laser light output to power the downhole amplifier.

In some embodiments, the first downhole laser comprises a quantum dot laser.

In some embodiments, the second downhole laser comprises a quantum dot laser.

In the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A system, comprising:
an optical fiber;
a downhole signal generator in optical communication with the optical fiber, the downhole signal generator to generate a signal to be transmitted along the optical fiber;
a downhole amplifier in optical communication with the optical fiber, the downhole amplifier to receive the signal from the downhole signal generator; and
a first downhole laser in optical communication with the downhole amplifier, the downhole laser to generate a first laser light output to power the downhole amplifier.

2. The system of claim 1, wherein the downhole laser is capable of operating at temperatures greater than approximately 75° C.

3. The system of claim 1, wherein the downhole signal generator comprises:
a second downhole laser in optical communication with the optical fiber, the second downhole laser to generate a second laser light output; and
a downhole modulator in optical communication with the second downhole laser, the downhole modulator to modulate the second laser light output to generate a telemetry signal.

4. The system of claim 3, wherein the optical fiber comprises the downhole modulator.

5. The system of claim 3, wherein the second downhole laser comprises the downhole modulator.

6. The system of claim 1, further comprising:
a second downhole amplifier connected in series or parallel with the first downhole amplifier.

7. The system of claim 6, further comprising:
a third downhole amplifier, wherein the first, second, and third downhole amplifiers are connected in series, parallel, or in a combination of series and parallel.

8. The system of claim 1, further comprising:
a receiver at a surface of the earth, the receiver in communication with the optical fiber to receive telemetry data via the optical fiber.

9. The system of claim 1, wherein the downhole laser comprises a quantum dot laser.

10. The system of claim 1, wherein the downhole laser is selected from the group consisting of: a vertical-cavity surface-emitting laser, a Fabry-Perot laser, a distributed feedback laser, and a cooled electro-absorption modulated laser.

11. The system of claim 1, further comprising:
a sensor to provide data to be included in the signal, the sensor selected from the group consisting of: a pressure transducer, a temperature transducer, a chemical sensor, a density sensor, a resistivity sensor, a magnetic field sensor, a radiation sensor, and a microseismic profiler.

12. The system of claim 1, wherein the system comprises a downlink telemetry system.

13. The system of claim 1, further comprising:
one or more downhole optical components optically coupled to the optical fiber, the one or more downhole optical components selected from the group consisting of: a depolarizer, a polarizer, a fiber stretcher, a coupler, a circulator, an isolator, a wavelength division multiplexer, a fiber Bragg grating, a faraday Rotator mirror, an optical receiver, a metallic-coated fiber mirror, an optical mixer, an optical filter, and a demultiplexer.

14. A method, comprising:
receiving, at a downhole amplifier, a signal from an optical fiber;
producing, at a downhole laser, a first laser light output to power the downhole amplifier; and
amplifying, at the downhole amplifier, the signal using the first laser light output.

15. The method of claim 14, further comprising:
generating the signal by generating, at a second downhole laser, a second laser light output to be received by a downhole modulator, and modulating, at the downhole modulator, the second laser light output to produce a telemetry signal.

16. The method of claim 14, wherein the signal comprises a down-going telemetry signal.

17. The method of claim 16, further comprising:
receiving, at a downhole receiver, the down-going telemetry signal.

18. The method of claim 14, further comprising:
receiving, at a receiver at a surface of the earth, the downhole signal via the optical fiber.

19. The method of claim 14, further comprising:
adjusting the first laser light output based on information provided by at least one sensor.

20. A non-remotely pumped telemetry system comprising:
a single mode optical fiber;
a first downhole laser in optical communication with the optical fiber, the first downhole laser to produce a first laser light output;
a downhole modulator in optical communication with the optical fiber, such that the downhole modulator modulates the first laser light output to produce a telemetry signal;
a downhole amplifier in optical communication with the optical fiber, the downhole amplifier to amplify the telemetry signal; and
a second downhole laser in optical communication with the downhole amplifier, the second downhole laser to produce a second laser light output to power the downhole amplifier.

21. The non-remotely pumped telemetry system of claim 21, wherein the first downhole laser comprises a quantum dot laser.

22. The non-remotely pumped telemetry system of claim 21, wherein the second downhole laser comprises a quantum dot laser.
